(19) United States
(12) Patent Application Publication
(10) Pub. No.: US 2007/0114816 A1
(43) Pub. Date: May 24, 2007

(54) Undercarriage liner made of plastic for a vehicle

(75) Inventors: Steffen Hoelzel, Ditzingen (DE); Markus Schmid, Moensheim (DE); Rudolf Reiche, Weissach (DE); Marco Pietro Giardini, Arcore (IT); Giovanni Motta, Briosco (IT)

Correspondence Address: CROWELL & MORING LLP;INTELLECTUAL PROPERTY GROUP, P.O. BOX 14300, WASHINGTON, DC, 20044-4300, US

(73) Assignees: Dr. Ing. h.c.f. Porsche Aktiengesellschaft, Stuttgart (DE); Ranger S.p.A, Carate Brianza (IT)

(21) Appl. No.: 11/476,618

(22) Filed: Jun. 29, 2006

(30) Foreign Application Priority Data
Jun. 30, 2005 (DE) 10 2005 030 913.5

(51) Int. Cl. B62D 25/20

(52) U.S. Cl. 296/204

(57) ABSTRACT

An undercarriage liner made of plastic for a vehicle is detachably attached to the adjacent vehicle chassis. In order for an undercarriage liner to have a significantly lower weight per unit of area, and thus a definitely reduced total weight, while retaining the same flexural strength and impact strength, the undercarriage liner, in the form of a sandwich structure, has a lightweight core layer of polypropylene foam or unconsolidated glass-mat-reinforced thermoplastic. The core layer is provided with a thin cover layer of polypropylene fiber-reinforced polypropylene on both sides. The two rigid and high-impact cover layers are each thermally bonded to the core layer.

This application claims the priority of German application 10 2005 030 913.5, filed Jun. 30, 2005, the disclosure of which is expressly incorporated by reference herein.

### BACKGROUND AND SUMMARY OF THE INVENTION

This invention relates to an undercarriage liner made of plastic for a vehicle.

Undercarriage liners are used for aerodynamic lining and protection of undercarriage structures of vehicles. Sports cars which reach high ultimate speeds particularly benefit from having the smoothest possible undercarriage liners. An undercarriage liner is exposed to both aerodynamic surface loads and impact stresses (e.g., when driving over snow or through water, at the approach to a ramp). Undercarriage liners are thus exposed primarily to bending stresses, but must also have adequate impact strength.

With known series-production sports cars, undercarriage liners made of compact fiberglass-reinforced thermoplastics, e.g. long-fiber-reinforced thermoplastics (LFT) or glass-mat-reinforced thermoplastics (GMT), are processed by compression molding or injection molding techniques. These manufacturing processes allow minimum component thicknesses of approximately 1.8 millimeters to 2.0 millimeters for large-area components. With the materials used here, this yields a minimum weight of approximately 2100 g/m². The total weight of an undercarriage liner having such a structure in a sports car amounts to as much as eight kilograms. Such an undercarriage liner is characterized by a relatively high bending strength and a good impact strength. However, it also has a considerable weight.

One object of this invention is to improve upon an undercarriage liner so that it will have a significantly lower weight per unit of area while maintaining the same bending stiffness and impact strength and thus have a definitely reduced total weight. In addition, the undercarriage liner should be made of only one or two groups of materials for reasons-pertaining to recycling and, furthermore, should be inexpensive to manufacture.

According to this invention, this object is achieved by way of an undercarriage liner made of plastic for a vehicle which is attachable to an adjacent vehicle body. The liner has a sandwich structure including a lightweight core layer made of polypropylene foam and a thin, rigid, high-impact cover layer made of polypropylene fiber-reinforced polypropylene on each side of the core layer, and each of the cover layers is thermally bonded to the core layer. The undercarriage liner is compacted to a thickness of approximately 1.0 millimeter to 1.5 millimeter at an edge of a component and at points of application of force.

Among the main advantages achieved with the present invention is the creation of an especially lightweight undercarriage liner by a sandwich structure having a lightweight core layer and two rigid high-impact cover layers of polypropylene-fiber-reinforced polypropylene. The bending stiffness and impact strength of this undercarriage liner is based mainly on the thin cover layers. Weight savings between 35% and 55% can be achieved, depending on the pairing of materials of the individual layers.

In a first embodiment of the invention, the light core layer is made of polypropylene foam. Since all the layers in this variant consist only of one group of materials, recycling of the undercarriage liner is greatly facilitated.

In a second embodiment, the core layer consists of a lightweight unconsolidated glass mat-reinforced thermoplastic with a high air content. The individual layers of the undercarriage liner can be thermally bonded together, preferably welded together, by a simple method. No gluing operation such as that conventionally used with sandwich elements is necessary here. In the area of the edge of the component and at the points of force introduction (fastening points), the undercarriage liner is compacted to a thickness of approximately 1.0 millimeter to 1.5 millimeters. The consolidated edges close the sandwich and thus prevent the penetration of dirt and moisture. In the area of application of force, the consolidation minimizes creep due to rear-end material and thus ensures long-term adhesion.

Embodiments of the present invention are illustrated by way of example in the drawings and are also explained in greater detail below.

### BRIEF DESCRIPTION OF THE INVENTION

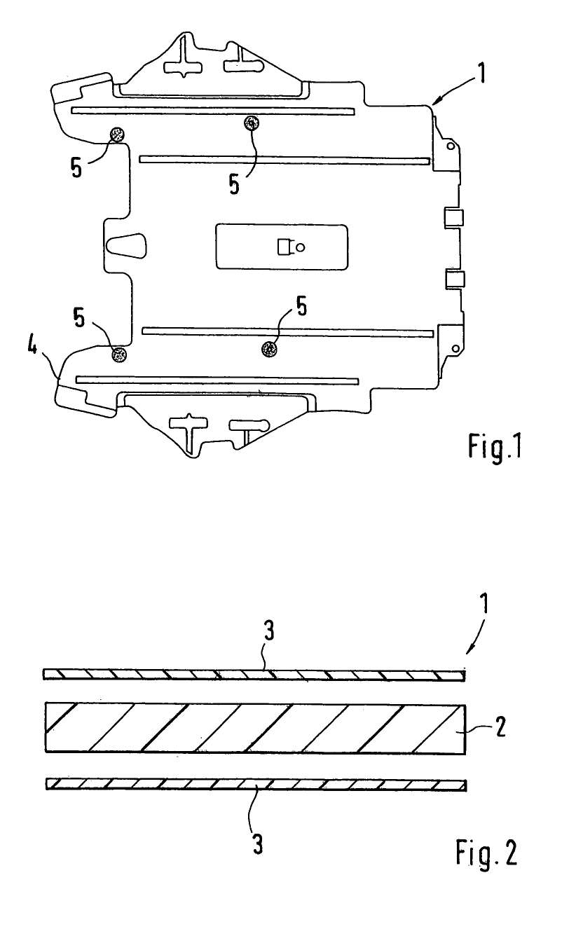

FIG. 1 shows a top view of an undercarriage liner for a motor vehicle, and

FIG. 2 shows a section through the undercarriage liner which has a sandwich structure, showing the individual layers in an exploded diagram.

### DETAILED DESCRIPTION OF THE INVENTION

An undercarriage liner 1 designed in one or more parts serves as an aerodynamic liner and to provide protection for the undercarriage structure of a motor vehicle and is held in position by means of detachable fastening elements (not shown in detail here) on the adjacent vehicle body above it.

According to this invention, the undercarriage liner 1 has a sandwich design with a lightweight core layer 2 and, preferably, a thin cover layer 3 on each side. In comparison with unconsolidated GMT, the novel undercarriage liner should largely derive its structural properties from the cover layers 3, not merely from the core layer 2. Therefore, the lightest possible core material and thin, lightweight, strong, rigid and extremely high-impact and abrasion-resistant cover layers 3 are required. Cover layers 3 reinforced with glass or carbon fibers are not suitable as cover layers because of their high minimal weight per unit of area and their low impact strength and abrasion resistance. Unreinforced polymer films, however, do not have a sufficiently high rigidity and strength to optimally utilize the lightweight construction potential of a sandwich element.

Polypropylene fiber-reinforced polypropylene is optimally suited as the material for the cover layer. It has a high rigidity and strength, an extremely good impact energy uptake, and a low density. Furthermore, films with a thickness of 0.15 millimeter or more are available on the market.

Lightweight cores based on polypropylene, e.g. polypropylene foam, are suitable as the core material and provide adequate support for the cover layers.

The two rigid and high-impact cover layers 3 are thermally bonded to the core layer 2, e.g. by welding. According to a first embodiment, the core layer 2 is made of polypropylene foam, and the polypropylene foam has a density of 70 to 150 kilograms per cubic meter. The two cover layers have a thickness between 0.15 millimeter and 0.5 millimeter, preferably 0.30 millimeter. The total thickness of the undercarriage liner in the sandwich area amounts to approximately 3.5 millimeters to 5 millimeters. The sandwich is compacted to a thickness of approximately 1.0 millimeter to 1.5 millimeters at the edge 4 of the component and at the points 5 of application of force. The weight per unit of area that can be achieved thus amounts to 800 grams per square meter to 1400 grams per square meter and results in weight savings between 30% and 60%.

An undercarriage liner 1 having such a structure is manufactured as follows: The three layers (the two cover layers 3 and the core layer 2) are either laminated directly to one another by the foam extrusion process or are assembled shortly before the compression molding process. The sandwich package is heated to the processing temperature (optionally clamped in a frame) in a heating station (e.g., a circulating air oven or an infrared oven) and then shaped in a press and cooled. This shaping operation is known as a punch-shaping method for shaping continuous fiber-reinforced thermoplastics.

The thermal process management and the use of similar materials make it possible to weld the cover layers 3 to the core material and not bond them with adhesive, as would otherwise be customary with sandwich elements. This eliminates the bonding operation while also facilitating subsequent recycling of materials.

A second embodiment of the undercarriage liner 1 differs from the first variant in that a core layer 2 based on polypropylene and consisting of a lightweight unconsolidated glass mat-reinforced thermoplastic with a high air content is provided. The core layer 2 has a weight of 800 grams to 1000 grams per square meter. In the second embodiment, the two cover layers 3 are also manufactured from polypropylene fiber-reinforced polypropylene and have thicknesses of approximately 0.15 mm each. The total thickness of the sandwich elements amounts to 3.5 millimeters to 5 millimeters. The weight per unit of area that can be achieved is thus 1100 grams to 1400 grams per square meter and results in weight savings between 30% and 50%.

In the second variant, the three layers (two cover layers and the core layer) are either laminated directly one on top of the other by the GMT manufacturing method or assembled shortly before the compression molding operation. The sandwich package is heated to the processing temperature in a heating station and then shaped in a press and cooled. This shaping operation is known as a punch-shaping operation for shaping continuous fiber-reinforced thermoplastics.

In both embodiments, the undercarriage liner 1 is compacted to a thickness of approximately 1.0 millimeter to 1.5 millimeter on the peripheral edge 4 of the component and at the points 5 of application of force (fastening points). Furthermore, a supporting surface directed toward the adjacent vehicle body is provided for reinforcing the undercarriage liner 1 in the area of the edge 4 of the component and the fastening points 5.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We claim:

1. An undercarriage liner made of plastic for a vehicle, the liner being attachable to an adjacent vehicle body and having a sandwich structure comprising:
a lightweight core layer made of polypropylene foam, and
a thin, rigid, high-impact cover layer made of polypropylene fiber-reinforced polypropylene on each side of the core layer,
wherein each of the cover layers is thermally bonded to the core layer.

2. The undercarriage liner as claimed in claim 1, wherein each of the two cover layers has a thickness between 0.15 millimeter and 0.5 millimeter, and wherein the undercarriage liner has a total thickness of approximately 3.5 millimeters to 5 millimeters.

3. The undercarriage liner as claimed in claim 1, wherein the undercarriage liner has a weight per unit of area of approximately 800 grams to 1400 grams per square meter.

4. The undercarriage liner as claimed in claim 1, wherein the undercarriage liner is compacted to a thickness of approximately 1.0 millimeter to 1.5 millimeter at an edge of a component and at points of application of force.

5. The undercarriage liner as claimed in claim 2, wherein the undercarriage liner is compacted to a thickness of approximately 1.0 millimeter to 1.5 millimeter at an edge of a component and at points of application of force.

6. The undercarriage liner as claimed in claim 3, wherein the undercarriage liner is compacted to a thickness of approximately 1.0 millimeter to 1.5 millimeter at an edge of a component and at points of application of force.

7. The undercarriage liner as claimed in claim 1, wherein the undercarriage liner is cut off or folded toward a vehicle chassis in the area of an edge of the component and at fastening points with respect to the adjacent contour of the undercarriage liner.

8. The undercarriage liner as claimed in claim 2, wherein the undercarriage liner is cut off or folded toward a vehicle chassis in the area of an edge of the component and at fastening points with respect to the adjacent contour of the undercarriage liner.

9. The undercarriage liner as claimed in claim 3, wherein the undercarriage liner is cut off or folded toward a vehicle chassis in the area of an edge of the component and at fastening points with respect to the adjacent contour of the undercarriage liner.

10. An undercarriage liner made of plastic for a vehicle, attachable to an adjacent vehicle body, and having a sandwich structure comprising:
a lightweight core layer made of a lightweight, unconsolidated, glass-mat-reinforced thermoplastic with a high air content, and
a thin, rigid, high-impact cover layer made of polypropylene fiber-reinforced polypropylene on each side of the core layer,
wherein each of the two cover layers is thermally bonded to the core layer.

11. The undercarriage liner as claimed in claim 10, wherein each of the cover layers has a thickness of approximately 0.15 millimeter.

12. The undercarriage liner as claimed in claim 10, wherein the undercarriage liner has a weight per unit area of approximately 1100 grams to 1400 grams per square meter.

13. The undercarriage liner as claimed in claim 10, wherein the undercarriage liner is compacted to a thickness of approximately 1.0 millimeter to 1.5 millimeter at an edge of a component and at points of application of force.

14. The undercarriage liner as claimed in claim 11, wherein the undercarriage liner is compacted to a thickness of approximately 1.0 millimeter to 1.5 millimeter at an edge of a component and at points of application of force.

15. The undercarriage liner as claimed in claim 12, wherein the undercarriage liner is compacted to a thickness of approximately 1.0 millimeter to 1.5 millimeter at an edge of a component and at points of application of force.

16. The undercarriage liner as claimed in claim 10, wherein the undercarriage liner is cut off or folded toward a vehicle chassis in the area of an edge of the component and at fastening points with respect to the adjacent contour of the undercarriage liner.

17. The undercarriage liner as claimed in claim 11, wherein the undercarriage liner is cut off or folded toward a vehicle chassis in the area of an edge of the component and at fastening points with respect to the adjacent contour of the undercarriage liner.

18. The undercarriage liner as claimed in claim 12, wherein the undercarriage liner is cut off or folded toward a vehicle chassis in the area of an edge of the component and at fastening points with respect to the adjacent contour of the undercarriage liner.

19. The undercarriage liner as claimed in claim 13, wherein the undercarriage liner is cut off or folded toward a vehicle chassis in the area of an edge of the component and at fastening points with respect to the adjacent contour of the undercarriage liner.

20. The undercarriage liner as claimed in claim 14, wherein the undercarriage liner is cut off or folded toward a vehicle chassis in the area of an edge of the component and at fastening points with respect to the adjacent contour of the undercarriage liner.
